(19) United States
(12) Patent Application Publication
(10) Pub. No.: US 2007/0286953 A1
(43) Pub. Date: Dec. 13, 2007

(54) Solution processible materials and their use in electronic devices

(76) Inventors: Charles D. MacPherson, Santa Barbara, CA (US); Frank P. Uckert, Buellton, CA (US)

Correspondence Address: MARK RODGERS, 1590 SAN ROQUE ROAD, SANTA BARBARA, CA, 93105, US

(21) Appl. No.: 11/803,450

(22) Filed: May 14, 2007

Related U.S. Application Data
(60) Provisional application No. 60/801,865, filed on May 20, 2006.

(51) Int. Cl. B05D 5/00; B29C 71/04; B05D 3/12

(52) U.S. Cl. 427/240; 427/256; 427/532; 427/430.1; 427/421.1; 427/355

(57) ABSTRACT

The invention describes a method or methods to create, or extend a two-dimensional (two-dimensional) electronic delocalization of a deposited solution processible material by energetic and/or chemical means for use in electronic devices. The process allows for a high degree of tunability in the extent of delocalization that occurs. Therefore the electronic properties can be tailored to various electronic target applications such as thin film transistors and photovoltaic devices.

### RELATED APPLICATIONS

This application claims priority to U.S. Provisional application, Ser. No. 60/801,865, filed May 20, 2006

### FEDERALLY FUNDED RESEARCH

### Not applicable

### SEQUENCE LISTING

### Not applicable

### BACKGROUND OF THE INVENTION

This application relates to solution processed materials, and in particular materials that may be conveniently processed in solution form, and then treated once deposited to produce material with properties suitable for electronic devices. An electronic device for purposes of this application may be a single diode or transistor, ranging up to complex systems such as sensors, computer systems, and cellular phones.

There is great interest in expanding the application of semiconductor devices into areas where the traditional semiconductor wafer manufacturing processes are not viable, such as circuitry deposited directly on glass, cloth or other non-wafer substrates. One promising approach is the use of organic materials, which would allow low temperature solution processing. Extensive research has been conducted over the last decade resulting in numerous scientific publications of organic based solution processible electronic devices. Solution processing starts with a material that can be dissolved, dispersed or suspended in a solvent or blend of solvents. The resulting solution or dispersion can be deposited on to a substrate which allows the deposition of the material from solution using common deposition or printing methods. Despite the attractive properties organic electronic materials possess, which are highly desirable in developing lower cost manufacturing methods, devices made from these materials are limited by a lack of performance, such as low operational speed, high operational voltage and low operational stability. While traditional synthesis methods attempt to improve the conductivity, charge transport properties and/or chemical stability of solution processible semiconductor materials by expanding the conjugation of electronic states to two-dimensions, the solubility of the material then becomes severely reduced and the solution processibility becomes difficult or impossible.

Thus there is a well defined need in the art to develop materials and manufacturing techniques where both solubility at critical points in a process, and adequate device performance at the end of the process can both be achieved.

### SUMMARY OF THE INVENTION

The invention in some embodiments is a unique electronic device element, and the process for producing the device. The process includes the steps of selecting a suitable material, such that the material is soluble in a precursor state, and convertible to a more extended delocalized state, dissolving the precursor in a solvent, depositing the solvent on a substrate in a pattern forming the element structure, and converting the deposited precursor to a more extended delocalized state. In some versions, the precursor may be a liquid itself, as opposed to a soluble substance.

In some versions, the conversion step is accomplished by an energetic process. The energetic process may include any combination of thermal, plasma, electron, or photon, irradiation, or chemical processes.

In some embodiments, the depositing step may include any-combination of spin coating, inkjet printing, dip coating, spray coating, slot die coating, offset printing, screen printing, or soft contact lithography.

In a preferred embodiment, the precursor material is PAN and the conversion process is thermal.

In another embodiment, the process includes the steps of selecting a suitable material, such that the material is soluble in a precursor state, and convertible to a more anisotropic state, dissolving the precursor in a solvent, depositing the solvent on a substrate in a pattern forming the element structure, and converting the deposited precursor to a more anisotropic state.

In various embodiments, the devices are chosen from the group consisting of field effect devices, photovoltaic, photoconductor, photodetector, printable electronic, RF shielding, light emitting devices, sensors, biosensors, micro-electro-mechanical systems (MEMS).

In various embodiments the precursor material is chosen from the group consisting of insulating materials such as polyvinylchloride (PVC), semiconducting materials such as poly(para-phenylenevinylene) (PPV), and conducting materials such as doped polyaniline.

### BRIEF DESCRIPTION OF THE FIGURES

The invention will be more readily understood by referring to the following figures:

FIG. 1 includes a proposed reaction mechanism for the thermal conversion of polyacrylonitrile (PAN) to a graphite-like material.

FIG. 2 shows a graph of resistivity vs pyrolysis temperature for PAN

FIG. 3 (a) A cross-sectional view of a precursor PAN film (2) deposited on to a substrate 1 prior to conversion. (b) the PAN film after conversion by energetic means.

FIG. 4 A thin film field effect transistor (TFT) with the converted PAN precursor film 2 as the electro-active layer of the device.

### DETAILED DESCRIPTION OF THE INVENTION

Here we describe processing methods to create or expand a two-dimensional delocalization of electronic states in a solution processible precursor material after deposition of that material. The solution processible material is preferably converted by energetic and/or chemical means for use in electronic devices. The converted material is used as the active component in electronic device(s). Since the conversion is performed after deposition from solution, the loss of solubility due to the generation of two-dimensional delocalized electronic states is not detrimental, and in fact, can be advantageous if additional solution processed layer(s) is (are) required in fabricating the electronic device.

After a fully solution processible precursor material is deposited, its electronic properties are modified by energetic and/or chemical means. The energetic and/or chemical process produces or extends two-dimensional delocalization of the precursor compound. The process allows for a high degree of tunability in the extent of delocalization that occurs and therefore the electronic properties can be tailored to target specific electronic applications such as thin film transistors and photovoltaic devices. Delocalization is defined as an electron system in which bonding electrons are not localized between two atoms as for a single bond, but are spread (delocalized) over several bonds. For example, n-electrons, in the aromatic (conjugated) system benzene are delocalized over the six carbon atoms comprising the ring structure. The extension of the two-dimensional delocalization of electronic states is defined as a increasing the number of neighboring atoms participating in a delocalized electronic bonding state in at least two of the three dimensions of space (x-axis, y-axis, z-axis). For example, in the case of the thermal pyrolysis of polyacrylonitrile (PAN), the bond order of the material is altered such that carbon s hybridized double bonds are created in the polymer material so as to produce a new molecular structure in which there are electronic states that encompass a larger number of atoms in two dimensions of the material than prior to the prolysis (conversion) process. The two-dimensional extension in delocalization may be extended by one or more atoms. A resulting electronic material after conversion may compose one or more of the following properties: high conductivity, high mobility, and high chemical and operational stability in an electronic device.

Since the conversion is carried out after the deposition, a decrease of solubility during the process is not detrimental, but in fact desirable because it allows the solution deposition of additional layers on top of the modified material without risk of re-dissolving the converted layer.

The choice of precursor materials is wide ranging. The basic requirement is that the material can be solution processed. Potential precursor compounds may include, but are not limited to, organic materials including polymers, inorganic materials including polymers, organometallic materials including polymers. In addition, blends and mixtures, as well as copolymers of two or more of all the above may be used as the precursor. Other potential precursor materials may include sugars, carbohydrates, amino acids, and proteins.

It is well known to experts in the field, that the polymers polyacrylonitrile (PAN) and polyimide, polyvinylchloride (PVC), which are electrically insulating, can be converted into high strength, high conductivity carbon fiber with numerous applications in the woven fiber industry.

The invention can also be practiced using conducting organic materials already possessing a 1-dimensional electronic delocalization, or conjugation, such as derivatives of polyaniline, polythiophene, polypyrrole, soluble and semiconducting organic materials derivatives, or precursors of poly(para-phenylene) (PPP), poly(para-phenylenevinylene) (PPV), poly(para-phenylene-ethynylene) (PPE), and polyacetylene (PA) polymers as the precursor, and extend the delocalization into a second dimension such that these materials now are more conductive and/or possess improved charge transport mobility after deposition.

Examples of inorganic precursors would include Si based compounds that can be converted to amorphous, poly, or single crystal silicon. The resulting material contains an increase in number of two-dimensional delocalized states thus imparting a higher degree of conductivity to the converted material than the initial precursor. Other potential inorganic semi-conducting materials that could be derived from solution processible precursors include, but not limited to, germanium, silicon carbide, III-V semiconductors and II-VI compounds.

The thickness of the deposited material can range from a monolayer to hundreds of microns in thickness, depending on the specific device application and the material used. The extension of two-dimensional delocalization is expected to reduce solubility of the material and therefore allow for the deposition of another solution processible layer and the possibility of another conversion process without re-disolving the first layer.

Another way to tune the electronic properties is to influence the orientation of the molecules on the substrate after and/or during deposition. Depending on the molecular structure and/or composition of the precursor and/or the deposition process, it is possible to obtain a material that after conversion exhibits anisotropic electronic properties. Some electronic applications may benefit from controlling the orientation of anisotropic electronic properties with respect to the substrate.

It is known to those skilled in the art that a variety of techniques can be used to deposit a solution processible precursor prior to extending the two-dimensional delocalization. These techniques include, but are not limited to, spin coating, inkjet printing, dip coating, spray coating, slot die coating, offset printing, screen printing, or soft contact lithography. The precursor can be dissolved, or dispersed into an appropriate solvent, or blend of solvents. The choice of solvent will depend on factors such as solubility, or dispersibility in a given solvent and the deposition method.

It will be recognized by those skilled in the art that the invention can be applied to a wide range of organic and inorganic materials and that a variety of energetic processes/methods can be used to produce the two-dimensional creation and/or extension of delocalized electronic states. These methods include, but are not limited to, thermal, plasma, electron, or photon, irradiation, chemical, or a combination of the above. In addition, the electronic properties of the converted precursor material after creation or expansion of the two-dimensional delocalization may differ with the conversion method, such as thermal, plasma, or electron bombardment. Specific examples of conversion methods include but are not limited to laser irradiation, ultra-violet radiation, microwave radiation, thermal and electron beam irradiation.

Advantages of the electronic materials with highly extended two-dimensional delocalized electronic states include high charge carrier mobility, thermal conductivity, asymmetrical conductivity, chemical stability, and/or excellent solar matching spectrum. None of these properties have been achieved with current solution-processible devices.

For carbon based materials, the process of extending the two-dimensional delocalized electronic structure can be referred to as graphitization. However, this invention is not limited to carbon based materials, but extends also to inorganic precursors and to combinations of organic and inorganic precursors. The extent to which the delocalization is created and/or expanded is dependant on the process used to initiate the graphitization and amount of time the material is exposed to the process.

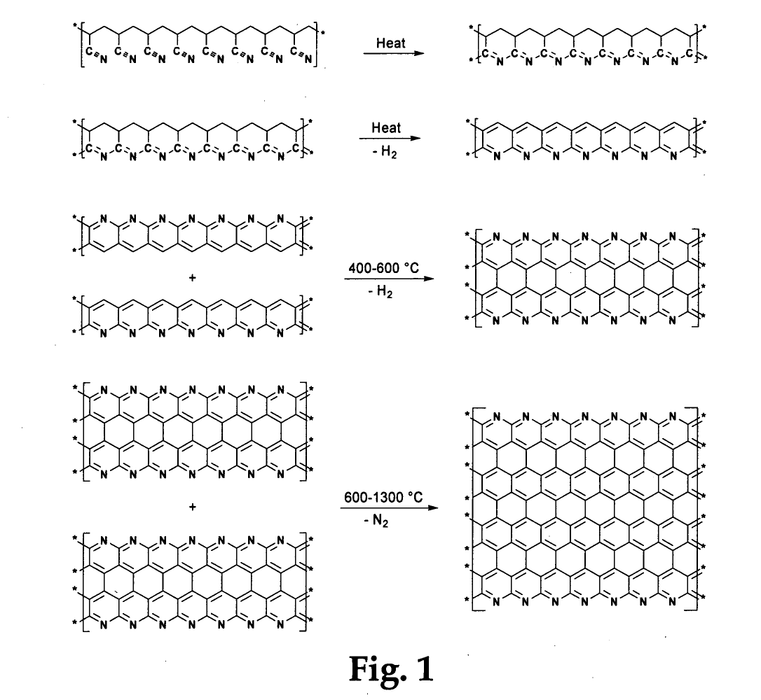

By way of example, a particular material suitable for practicing the various embodiments of the invention will be described, PAN, and the invention will be detailed for this particular material In the case of PAN, one method to initiate the graphitization process is by thermal treatment to temperatures greater than 200 degrees Celsius (see FIG. 1).

In FIG. 1 the starting material PAN is an insulator material in which the molecular structure contains no delocalized electronic states. This material, shown at the top of the figure is readily soluble in a range of process-suitable solvents. With heating to 200 degree Celsius, a ring closing reaction occurs to form a series of six membered rings, shown in the second row of the figure. The electrical conductivity remains extremely low for this intermediate species. However, with continued heating at temperatures greater than 200 degree Celsius there is a loss of hydrogen atoms within the ringed compound which is released as hydrogen gas. The loss of hydrogen from the molecular structure results in the formation of aromatic regions and delocalized electronic states. The electrical insulator PAN undergoes changes in its molecular structure during the heating process that result in a further increase in conductivity such that the material is transformed into a semiconducting state. As shown in FIG. 1, increased heating to a temperature between 400-600 degree Celsius results in an expansion of the two-dimensional delocalized electronic structure in the film through further loss of hydrogen and nitrogen, shown in row 3. The expansion of the two-dimensional delocalized electronic states in the film produces an increase in the electrical conductivity of the film. Additional heating at increasing temperatures (600 degree Celsius to 1300 degree Celsius (or greater) continues the reaction that increases the two-dimensional electronic delocalization (graphite-like molecular structure) within the film and thus further increases the electrical conductivity of the film.

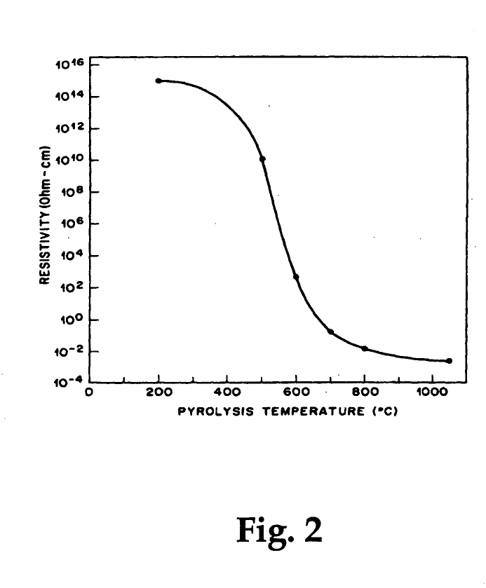

The changes in electrical resistivity of the initial deposited film as the chemical reaction illustrated in FIG. 1 proceeds during thermal conversion process is shown in FIG. 2. The electrical properties of the PAN film change as the conversion process proceeds resulting in a dramatic decrease in electrical resistivity. The extent to which a graphite-type (graphene) structure in PAN is generated depends on the exact temperature and the duration of heat exposure. The higher the temperature, the faster the rate at which graphitization occurs. With sufficient temperature and treatment time, the highly electrically insulating starting material (PAN) can be converted into a highly conductive material with properties similar to that of pyrolytic graphite. At various stages in this conversion process, there are a wide range of electronic properties and conductivities that the material transitions through during its conversion to pyrolytic graphite. Simply put, the starting material is a soluble insulator, and the ending material is an insoluble conductor. The states in-between are partial or wholly insoluble semiconductors. Many of these states may possess electronic properties that can form the basis of an electronic device.

By energetic means such as thermal treatment, a two-dimensional electronic conjugation can be created in, the insulating material, PAN, and the extent of this conjugation can be controlled by the process conditions. Numerous electronic properties can be obtained by the process depending on the exact nature and amount of conversion time that is performed on the PAN. The final electronic properties of the converted PAN can be controlled to produce a material with desired electronic properties.

Thus the material may be solution processed in a state that is not suitable for electronic device creation, printed on a variety of substrates, such as glass, plastic, cloth or other materials, and then converted in place into semiconductor material suitable for device fabrication. In the case of PAN, molding the dissolved precursor into a desired configuration, and then processing through to the point of a finished graphite structure is a known process for making mechanical graphite objects, such as golf clubs, tennis rackets and the like. To date no one has recognized that the intermediate states, heretofore passed over in all known processes, hold the ideal answer to solution processible electronic devices.

Depending on the conversion method, any other necessary process steps needed to produce the desired electronic device can be performed either prior to the conversion, or after, depending what is considered to be the most feasible route to fabrication of the electronic device. For example, in the case of the thermal treatment of PAN to generate the graphitization process, it may be more practical to add any needed electrical contacts and dielectric materials after the conversion process, if high temperatures such as 1000 degree Celsius are used. By performing these fabrication process steps after the conversion step, one can avoid potential damage to the metallic contacts and dielectric layers required to complete the device. In other cases, the conversion process may not affect other materials added in the fabrication and therefore the steps can be preformed prior to conversion. The exact sequence in the fabrication process can be arranged to maximize the manufacturing yield of the electronic device. It can also be recognized by those skilled in the art that an electronic device may be composed of more than one solution processible layers, that may have each undergone an extension of two-dimensional delocalization by some energetic means and that the layers may be composed of the same material, or may be of different chemical composition. The method of two-dimensional delocalization extension does not necessarily need to be the same for each of the converted layers. For example thermal energy maybe used to convert one layer and another deposited layer may be converted by plasma energy.

Potential application for the electronic materials may include, but are not limited to field effect devices, photovoltaic, photoconductor, photodetector, printable electronic, RF shielding, light emitting devices, sensors, biosensors, micro-electro-mechanical systems (MEMS).

As stated above, in one embodiment the solution processible precursor polymer PAN is dissolved in at least one solvent. The particular solvent, or blend of solvents that is selected is dependant on the chemical and physical properties of the precursor material, the solids loading, viscosity of the resulting solution, the targeted thickness, substrate temperature and morphology of the deposited film after the removal of excess solvent, type of deposition/printing or any combination thereof.

Alternatively, the precursor material may form an emulsion, suspension, or a dispersion in a liquid medium or blend of liquids.

Deposition of the precursor solution, emulsion, suspension, or dispersion can be accomplished by techniques including, but not limited to, inkjet printing, spin coating, dip coating, slot die coating, offset printing, screen printing, and gravature printing. To those skilled in the art will recognize that selected deposition method will be determined by the rheological characteristics of the precursor solution, type of substrate, required thickness of the deposited film and the type electronic device being manufactured, or any combination thereof.

The choice of substrate includes quartz, silicon wafers, silicon dioxide wafers, borosilica glass, soda lime glass, silicon carbide, polycarbonate, polyester, and polyimide. The above listed substrates are meant not as complete list, but as examples. It will be appreciated by those skilled in the art that the selection of a particular substrate and its physical and chemical properties will be an important factor in the choice of conversion method for the deposited precursor film. The choice of substrate and conversion method must be selected such that the conversion process does not lead to chemical or physical damage of the substrate if the result was to cause a deterioration in the performance of the manufactured electronic device.

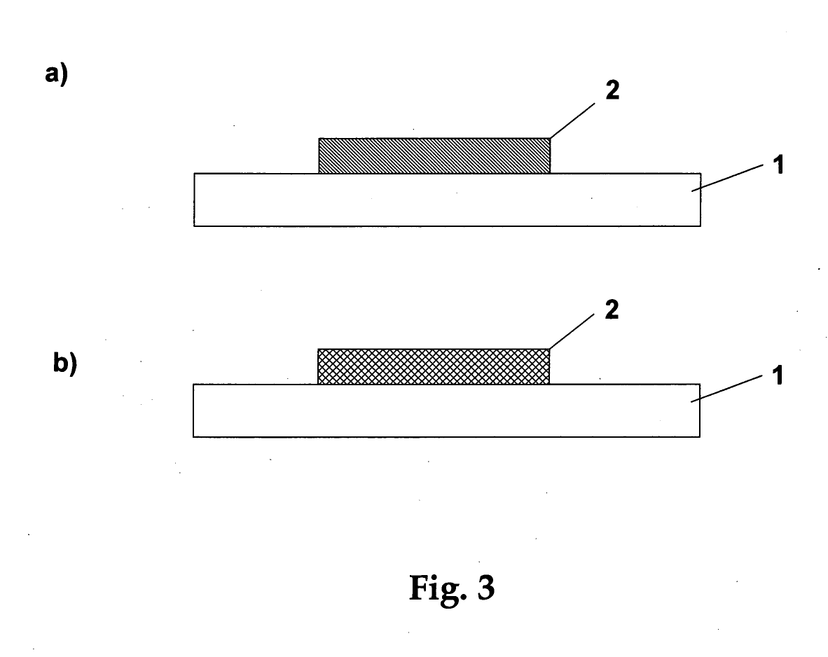

In one particular embodiment, the creation of a two-dimensional delocalized electronic structure, as illustrated in FIG. 3b, from the deposited precursor PAN film 2 in FIG. 3a is achieved by heating the precursor PAN film 2 to temperatures greater than 200 degC.

In other embodiments, a delocalized two-dimensional electronic structure is created in the deposited precursor PAN film 2 of FIG. 3a by energetic means including, but not limited to, plasma energy, electron beam, photo irradiation with a wavelength between 150 nm to 10000 nm, microwaves, radio-frequency, or irradiation with a laser source. These energetic processes can be used as an alternative to thermal conversion, or in combination with heating, or any combination thereof. The selection of an energy source to create or extend the two-dimensional delocalized electronic structure (conversion process) of a deposited precursor film will depend on factors including the amount of energy required to initiate the conversion process, chemical properties of the precursor film, type of substrate and compatibility with a given energetic process.

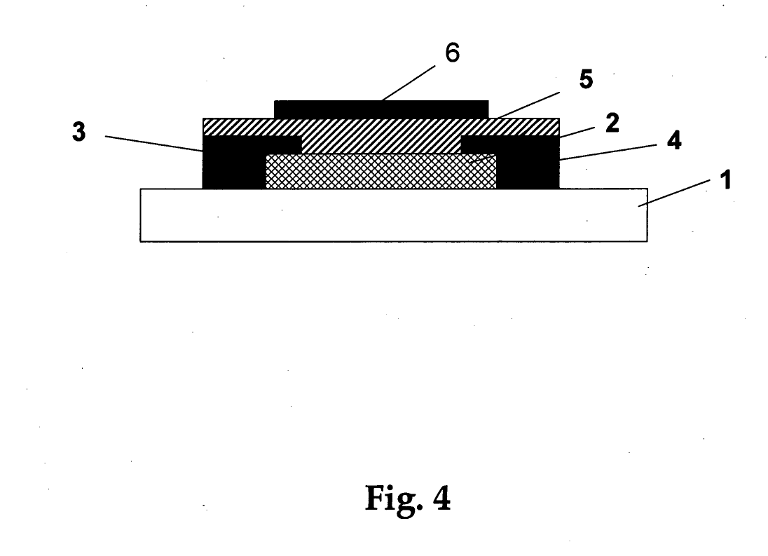

In a specific embodiment, a thin film field effect (TFT) device as shown in FIG. 4 is produced from the converted PAN film with the addition of source 3 and drain 4 electrical contacts. The source and drain contacts can be formed from traditional metal used in semiconductor by traditional lithographic processes, or organic conducting polymers, or graphite deposited solution processing techniques. A gate insulator 5 is deposited on top of the electro-active converted precursor material. The gate insulator can be an inorganic material including silicon dioxide, silicon nitride, aluminum oxide, aluminum nitride or organic materials (examples include but are not limited to polyimide, parylene, photoresist, benzocyclobutene and polyvinylphenol). A top gate electrode 6 is deposited onto the gate insulator 5. The gate contact can be formed from traditional metal used in semiconductor processing using traditional lithographic processes or organic conducting polymers, or graphite deposited solution processing techniques.

In some embodiments the precursor can be a liquid at room temperature or at higher temperature. Then it is possible that the precursor can be deposited by solution processing without the addition of a solvent.

While one (or more) embodiment(s) of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto. In particular, the use of PAN has been extensively described as its precursor, intermediate and final states are known, and its precursor solubility and subsequent converted properties are appropriate for many applications. However, many other materials have the potential for initial solubility followed by conversion in place.

We claim:

1. A process for producing an element of an electronic device, comprising;
selecting a suitable material, wherein the material is soluble in a precursor state, and convertible to a more extended delocalized state,
dissolving or dispersing the precursor in a solvent, depositing the solvent on a substrate in a pattern forming the element structure; and,
converting the deposited precursor to a more extended delocalized state.

2. The process of claim 1 wherein the conversion step is accomplished by an energetic process.

3. The process of claim 2 wherein the energetic process includes any combination of thermal, plasma, electron, or photon, irradiation, or chemical processes.

4. The process of claim 1 wherein the depositing step includes any combination of spin coating, inkjet printing, dip coating, spray coating, slot die coating, offset printing, screen printing, or soft contact lithography.

5. The process of claim 1 wherein the precursor material is PAN.

6. The process of claim 1 wherein the conversion process is thermal.

7. An element of an electronic device, produced by the process of;
selecting a suitable material, wherein the material is soluble in a precursor state, and convertible to a delocalized state,
dissolving the precursor in a solvent,
depositing the solvent on a substrate in a pattern forming the element structure; and,
converting the deposited precursor to a delocalized state.

8. The device element of claim 7 wherein the conversion step is accomplished by an energetic process.

9. The device element of claim 8 wherein the energetic process includes any combination of thermal, plasma, electron, or photon, irradiation, or chemical processes.

10. The device element of claim 7 wherein the depositing step is includes any combination of spin coating, inkjet printing, dip coating, spray coating, slot die coating, offset printing, screen printing, or soft contact lithography.

11. The device element of claim 7 wherein the precursor material is PAN.

12. The device element of claim 7 wherein the conversion process is thermal.

13. The element of claim 7 wherein the devices are chosen from the group consisting of field effect devices, photovoltaic, photoconductor, photodetector, printable electronic, RF shielding, light emitting devices, sensors, biosensors, micro-electro-mechanical systems (MEMS).

14. The element of claim 7 wherein the precursor material is chosen from the group consisting of polyimide, polyvinylchloride (PVC), poly(para-phenylene) (PPP), poly(para-phenylenevinylene) (PPV), poly(para-phenylene-ethynylene) (PPE).

15. A process for producing an element of an electronic device, comprising;
selecting a suitable material, wherein the material is soluble in a precursor state, and convertible to a more anisotropic state,
dissolving or dispersing the precursor in a solvent, depositing the solvent on a substrate in a pattern forming the element structure; and,
converting the deposited precursor to a more anisotropic state.

16. A process for producing an element of an electronic device, comprising;
selecting a suitable material, wherein the material is a liquid in a precursor state, and convertible to a more extended delocalized state,
depositing the precursor on a substrate in a pattern forming the element structure; and,
converting the deposited precursor to a more extended delocalized state.

17. An element of an electronic device, produced by the process of;
selecting a suitable material, wherein the material is liquid in a precursor state, and convertible to a delocalized state,
depositing the precursor on a substrate in a pattern forming the element structure; and,
converting the deposited precursor to a delocalized state.
